(19) United States
(12) Patent Application Publication
(10) Pub. No.: US 2011/0164676 A1
(43) Pub. Date: Jul. 7, 2011

(54) DISTRIBUTION SERVER, DISTRIBUTION SYSTEM, METHOD, AND PROGRAM

(76) Inventor: Kazunori Ozawa, Tokyo (JP)

(21) Appl. No.: 13/062,762

(22) PCT Filed: Sep. 25, 2009
(86) PCT No.: PCT/JP2009/066630

§ 371 Date: Mar. 8, 2011

(30) Foreign Application Priority Data
Sep. 26, 2008 (JP) 2008-248153

(51) Int. Cl. H04N 11/02

(52) U.S. Cl. 375/240.01; 375/E07.026

(57) ABSTRACT

Disclosed is a distribution server that receives as an input a compressed/encoded stream or packet of a moving image or a still image, performs conversion that enhances resolution and image quality of the input, and distributes the converted stream or packet to a mobile terminal via a mobile network.

### REFERENCE TO RELATED APPLICATION

This application is the National Phase of PCT/JP2009/066630, filed Sep. 25, 2009, which is based upon and claims the benefit of the priority of Japanese patent application No. 2008-248153 filed on Sep. 26, 2008, the disclosure of which is incorporated herein in its entirety by reference thereto.

### TECHNICAL FIELD

The present invention relates to an information distribution technology, and more particularly to a distribution server, distribution system, and method for distributing a moving image stream or a still image stream that is compressed/encoded.

### BACKGROUND

With an introduction of the Next Generation Network (NGN) as well as an increase in bandwidth and speed of a mobile network, distribution services of high-quality moving images and still images are expected to increase in future. For example, moving image content is compressed/encoded in order to transmit the content efficiently at a low bit rate. As a compression/encoding scheme, ITU-T (International Telecommunication Union for Telecommunication Standardization sector) Recommendation H.263 and MPEG-4 (Moving Picture Experts Group Phase 4) internationally standardized by ISO/IEC (International Organization for Standardization/International Electro technical Commission) are known. In addition, H.264/MPEG-4 AVC (Advanced Video Coding), internationally standardized by ITU-T and ISO/IEC, compresses data more efficiently than the moving image compression/encoding schemes described above.

Patent Document 1 discloses a stream server that carries out content distribution that matches processing capability of a user terminal. Patent Document 2 discloses a configuration in which JPEG (Joint Photographic Experts Group) 2000 is used to create complementary pixels to provide higher-quality moving images using the DSC (Distributed Source Coding) system (system that divides a information source, performs encoding of the divided information separately and, combines the divided information to decode the combined information). Patent Document 3 discloses a moving image transmission server that converts original moving image data into intermediate moving image data and generates a transmission moving image having size and frame rate of a reproduced image corresponding to a mobile phone. As will be apparent from the description below, the present invention is absolutely different from the inventions described in those Patent Documents.

### Patent Document 1:

### WO2004/040908 A1

### Patent Document 2:

Japanese Patent Kokai Publication No. JP-P2007-74306A

### Patent Document 3:

Japanese Patent Kokai Publication No. JP-P2008-136045A

### SUMMARY

All the disclosed contents of Patent Documents 1-3 given above are hereby incorporated by reference into this specification.

The following gives an analysis of the present invention.

Because the network bandwidth is limited when data is distributed to a mobile network or the Internet, a screen resolution used for content such as a moving image is QCIF (Quadrature Common Intermediate Format) and, in addition, data is compressed/encoded at a relatively low bit rate of 64 kbps-128 kbps. And so, such content has insufficient resolution and image quality when reproduced on a terminal, making it difficult for the content distribution service to be widely used.

On the other hand, because a large volume of content has already been created using formats described above, there is a need for utilizing the already created content also when the network bandwidth is increased in future. In this case, the problem is that no mechanism is available today for utilizing such content.

In view of the foregoing, it is an object of the present invention to provide a distribution server, system, method, and terminal that make it possible to utilize content which is relatively low in a bit rate and a screen resolution and to enhance resolution and image quality at a destination to which the content is distributed.

The invention disclosed in this specification provides the following general configuration, though not limited thereto.

According to one aspect of the present invention, there is provided a distribution server comprising a conversion unit that receives a compressed /encoded signal of a moving image or a still image, and performs conversion that enhances resolution and image quality of the received signal; and a distribution unit that distributes the converted signal to a terminal via a network.

According to the present invention, there is provided a distribution method comprising:

receiving a compressed/encoded signal of a moving image or a still image;

performing conversion that enhances resolution and image quality of the received signal; and

distributing the converted signal to a terminal via a network.

According to the present invention, there is provided a program causing a distribution server to execute:

processing that receives a compressed/encoded signal of a moving image or a still image, and performs conversion that enhances resolution and image quality of the received signal; and

processing that distributes the converted signal to a terminal via a network.

According to the present invention, there is provided a system comprising a terminal that receives a compressed/encoded signal of a moving image or a still image distributed thereto; and a distribution server that receives a compressed/encoded signal of a moving image or a still image, performs conversion that enhances resolution and image quality of the received signal, and distributes the converted signal to the terminal via the network.

The present invention makes it possible to utilize content having a relatively low bit rate and a low screen resolution and to increase the image resolution or the image quality at a content distribution destination.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a system configuration of one exemplary embodiment of the present invention.

FIG. 2 is a diagram showing a configuration of a distribution server apparatus in one exemplary embodiment of the present invention.

FIG. 3 is a diagram showing a configuration of a distribution server apparatus in another exemplary embodiment of the present invention.

FIG. 4 is a diagram showing a configuration of a mobile terminal in another exemplary embodiment of the present invention.

FIG. 5 is a diagram showing a processing procedure of the distribution server apparatus in one exemplary embodiment of the present invention.

FIG. 6 is a diagram showing a processing procedure of the distribution server apparatus in another exemplary embodiment of the present invention.

FIG. 7 is a diagram showing a processing procedure of a mobile terminal in one exemplary embodiment of the present invention.

FIGS. 8A and 8B are diagrams showing a modification of the distribution server apparatus and the mobile terminal in one exemplary embodiment of the present invention.

### PREFERRED MODES

Modes of the present invention will be described below. In one of modes of the present invention, there is provided a distribution server that comprises a conversion unit that receives a compressed /encoded stream or packet of a moving image or a still image, and performs conversion that increases resolution and image quality of the received stream or packet; and a distribution unit that distributes the converted stream or packet to a terminal via a network.

In one of modes of the present invention, there is provided a distribution system in which, on receipt of a compressed /encoded stream or packet of a moving image or a still image, determines, based on a network bandwidth or a terminal capability, whether

to perform conversion that enhances resolution and image quality of the received signal by a server and to distribute the converted signal to a terminal over a network, or

to distribute the received signal to the terminal over the network without the conversion and to cause the terminal to perform conversion that enhances resolution and image quality of the received signal and to output the converted signal.

In one of modes of the present invention, there is provided a distribution system in which, on receipt of a compressed/encoded stream or packet of a moving image or a still image, a server distributes the received signal to a terminal over a network and the terminal performs conversion for the received signal by increasing the resolution and the image quality and outputs the converted signal.

The present invention implements a distribution server that allows a user to utilize a content bit stream of compressed moving image, which is created so far, for distribution to mobile terminals or to the Internet and which has a relatively low bit rate and a low screen resolution, and allows a server to perform conversion that increases resolution and image quality and to distribute the converted stream via the NGN or a mobile network whose bandwidth will be increased in future.

The present invention also implements a distribution system that allows a user to utilize a content bit stream of compressed moving image, which is created so far for distribution to mobile terminals or to the Internet and which has a relatively low bit rate and a low screen resolution, and allows the server to determine, based on a network bandwidth or a terminal capability, whether the server converts and distributes the bit stream or the server distributes the bit stream without conversion and causes the terminal to enhance resolution and image quality.

Although the present invention is applicable not only to video (moving image) content but also to still image content, an example of the configuration in which the present invention is applied to video content will be described in the exemplary embodiments given below. Although the present invention uses a mobile network (mobile circuit-switched network, mobile packet network, 3.9G network, 4G network, and so on), the Internet, a fixed packet network, or an NGN as a network between a distribution server and a terminal, an example in which the present invention is applied to a mobile packet network will be described in the exemplary embodiments given below.

### EXEMPLARY EMBODIMENTS

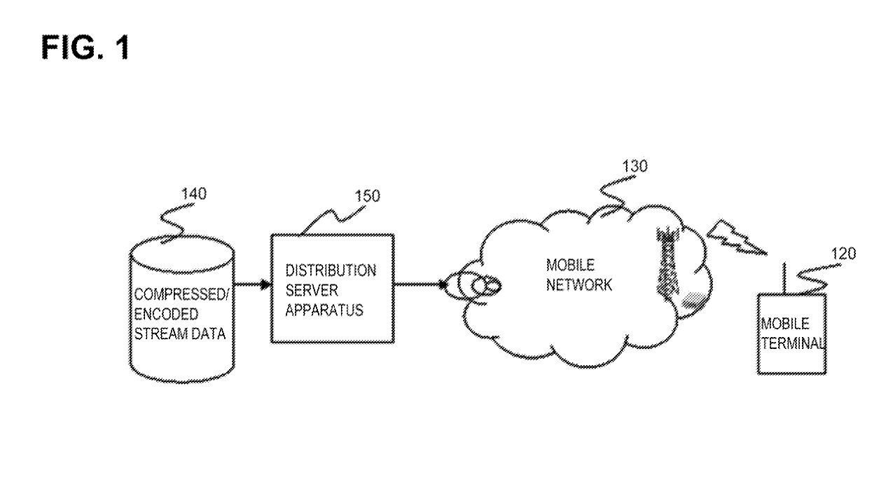

FIG. 1 is a diagram showing a system configuration of one exemplary embodiment of the present invention. The figure shows an example of the mode of connection between a distribution server and a mobile terminal via a mobile network.

In FIG. 1, compressed/encoded stream data 140 is obtained by performing compression/encoding of moving image content in advance using a moving image codec and by accumulating the obtained compressed/encoded streams for various types of content. Any moving image codec may be used. In the present exemplary embodiment, H.264 is used, as one example. For the detail of H.264, refer to ISO/IEC 14496-10 AVC ITU-T Rec. H.264 International Standard for Advanced Video Coding standard.

A distribution server apparatus 150 performs processing for a call from a mobile terminal 120, reads a compressed/encoded stream corresponding to moving image content, specified by the mobile terminal 120, from the compressed/encoded stream data 140, performs conversion that enhances resolution and image quality of the stream data and, then, distributes the converted stream data to the mobile terminal 120 via a mobile network 130.

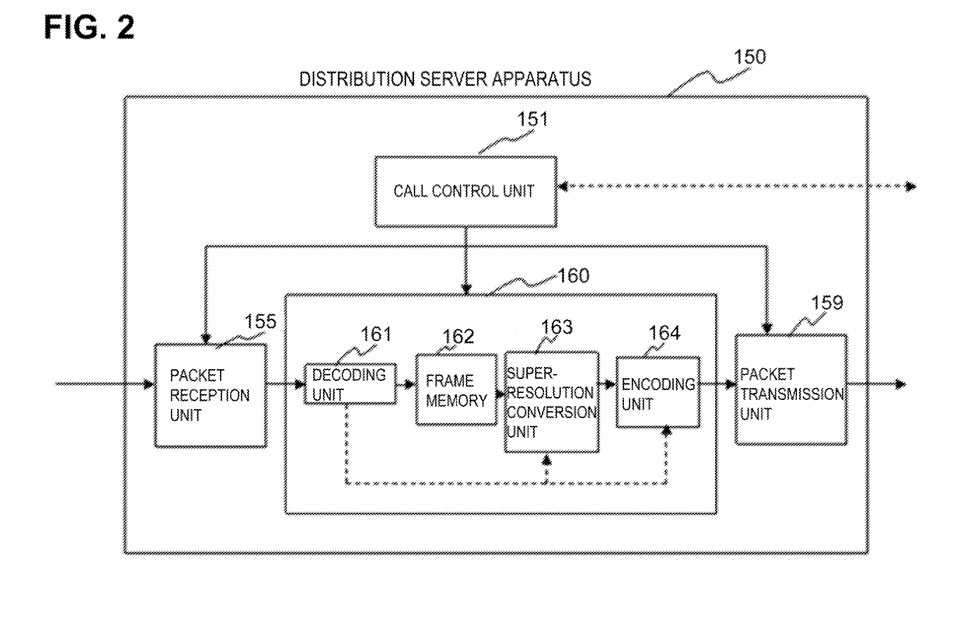

FIG. 2 is a diagram showing an example of the main part configuration of the distribution server apparatus 150. Referring to FIG. 2, the distribution server apparatus 150 comprises a packet reception unit 155, a call control unit 151, a conversion unit 160, and a packet transmission unit 159. The following describes each of the units.

The call control unit 151 receives a session control signal, using a SIP signal or an RTSP (Real Time Streaming Protocol) signal, from the mobile terminal 120. The call control unit 151 also receives capability information on the mobile terminal, using SDP (Session Description Protocol). For detail of SIP, RTSP, and SDP, see IETF (Internet Engineering Task Force) RFC (Request for Comments) 3261, RFC2326, and IETF RFC 2327 respectively. In this exemplary embodiment, the session is controlled by RTSP.

When a session start instruction using RTSP and the capability information on the terminal using SDP are received from the mobile terminal 120, the call control unit 151 instructs the packet reception unit 155 to read the compressed/encoded stream, corresponding to the content specified by the mobile terminal, from the compressed/encoded stream data 140.

The call control unit 151 outputs the capability information on the mobile terminal to the conversion unit 160 and also outputs the information, such as a reception IP address of the mobile terminal, to the packet transmission unit 159.

The packet reception unit 155 receives the compressed/encoded stream, corresponding to the content specified by the mobile terminal, from the compressed/encoded stream data 140, as an RTP packet, extracts the compressed/encoded stream stored in a payload of the RTP packet, and outputs the extracted stream to the conversion unit 160.

The conversion unit 160 comprises a decoding unit 161, a frame memory 162, a super-resolution conversion unit 163, and an encoding unit 164. The decoding unit 161 decodes the compressed/encoded stream, received from the packet reception unit 155, using a decoder that has the same scheme as that of an encoder used for compressing/encoding the content (for example, MPEG-4 SP (Simple Profile) or H.263 BP (Baseband Profile) is usually used for creating content to be distributed to mobiles), and stores the decoded signal in the frame memory 162.

The super-resolution conversion unit 163 receives the capability information on the mobile terminal 120 from the call control unit 151 and performs conversion which enhances image quality by extending a screen resolution in the range of the capability information. For example, when the capability information on the mobile terminal indicates H.264 BP (Baseband Profile) level 1.2, the information means that the bit rate is 384 kbps (kilobits/second), the screen resolution is CIF, and the frame rate is 15 fps (frames/second).

The super-resolution conversion unit 163 reads the signal stored in the frame memory 162 and improves the image quality by increasing the screen resolution. In the description below, it is assumed that the resolution of QCIF is extended to the resolution of CIF.

To extend the resolution, one of the following techniques is used.

The resolution is increased by increasing the number of pixels using a plurality of image frames as a reference image for an image frame to be converted; and

The number of pixels is increased using pixels in different positions in an image frame to be converted.

The super-resolution conversion unit 163 may be configured to select an optimal technique from those techniques under constraint of an operation amount and a memory amount that may be allotted to the processing of the super-resolution conversion unit 163.

When a past (previous in time) reference frame is used for a frame to be converted, the super-resolution conversion unit 163 receives a motion vector of each of macro-blocks decoded by the decoding unit 161 and re-executes motion vector search processing (determines the position of a macro-block which is one of the macro blocks in a search range of the reference frame and whose difference from the macro-block of the frame to be converted is the smallest) for pixels included in the macro-block based on the motion vector to find a detailed motion vector (for example, on a half-pixel basis). The super-resolution conversion unit 163 may employ a configuration in which the number of pixels of the frame to be converted is increased by applying the detailed motion vector, determined by the re-search, to pixels of the past reference frame and by using a frame that is moved according to the detailed motion vector. The super-resolution conversion unit 163 may also employ a configuration in which, instead of using a motion vector of a macro-block received from the decoding unit 161, the motion vector is searched for from a frame to be converted (current frame) and a reference frame.

When only a frame whose resolution is to be extended is used, the super-resolution conversion unit 163 enhances resolution and improves image quality by performing the processing in which an edge part is detected and an increase in the number of pixels is applied to pixels near the edge, or pixels near the edge are corrected or in which the edge part is detected and is emphasized. This processing is performed for a moving image and/or a still image.

By estimating a motion direction, the super-resolution conversion unit 163 interpolates a frame image in a temporal direction (inserts one frame between preceding and following frames) and interpolates a frame rate to increase the frame rate, for example, from 15 fps to 30 fps.

The encoding unit 164 receives capability information on the mobile terminal 120 from the call control unit 151, receives an output signal from the super-resolution conversion unit 163, and sets up a compression scheme and parameters according to the capability information. Because the screen resolution and the image quality have been increased by the super-resolution conversion unit 163, the maximum value of the capability information corresponding to H.264 BP@L1.2, screen resolution: CIF, bit rate: 384 kbps, frame rate: 15 fps and so forth may be used.

To reduce calculation amount of the motion vector search, the encoding unit 164 may also be configured to receive motion vector information from the decoding unit 161 and, based on the received motion vector information (conversion corresponding to extension in the resolution is performed for the motion vector), to search a neighborhood of the motion vector for a new motion vector in the image signal converted by the super-resolution conversion unit 163.

The packet transmission unit 159 receives a reception IP address of the mobile terminal 120 from the call control unit 151, receives a compressed/encoded stream from the encoding unit 164, and stores the stream in an RTP payload to transmit the stream as an RTP packet to a network.

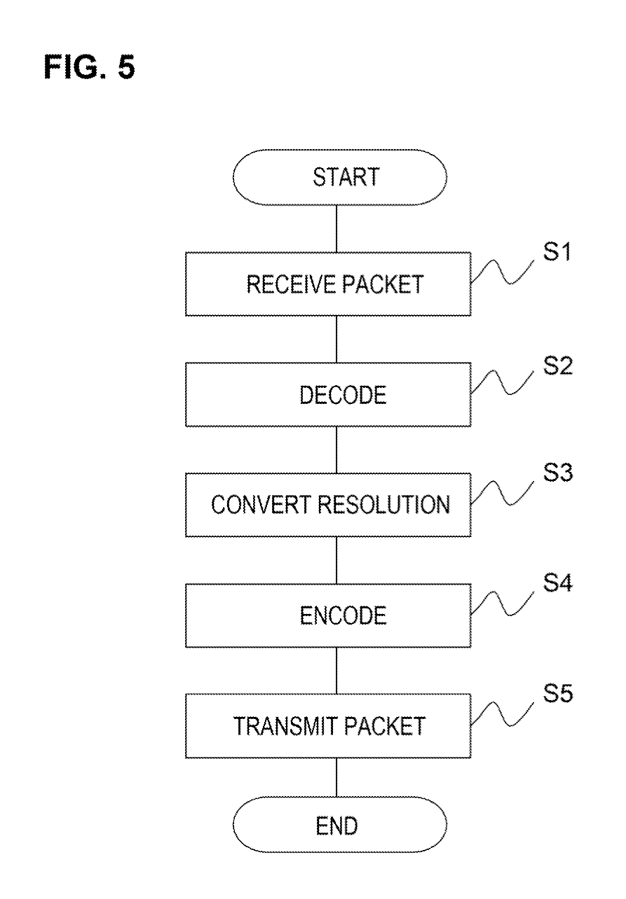

The following describes the processing procedure of the distribution server apparatus 150 in this exemplary embodiment with reference to FIG. 5.

Step S1: The packet reception unit 155 receives an RTP packet and transmits the compressed/encoded stream to the decoding unit 161.

Step S2: The decoding unit 161 decodes the stream.

Step S3: The super-resolution conversion unit 163 improves the image quality by extending the resolution of the decoded image.

Step S4: The encoding unit 164 encodes the signal output from the super-resolution conversion unit 163, based on the capability information on the mobile terminal 120 output from the call control unit 151.

Step S5: The packet transmission unit 159 receives the encoded signal from the encoding unit 164 and stores the signal in an RTP payload to transmit an RTP packet.

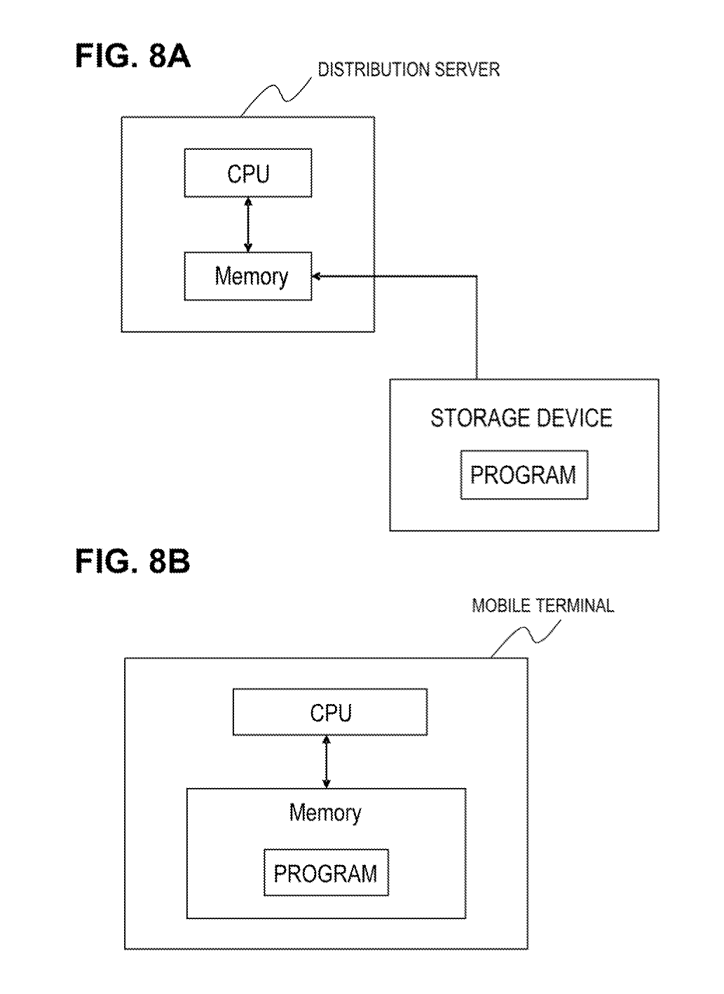

The function and the processing of steps S1 to S5 of the distribution server described above may of course he implemented by a program executed on a computer configuring the distribution server apparatus. As shown in FIG. 8A, the computer (CPU) that configures the distribution server apparatus implements the processing of the conversion unit, packet reception unit, packet transmission unit, and call control unit described above by loading one or more programs from the storage device into a memory for execution therein. The storage device, in which the programs are stored, may of course be connected to the distribution server apparatus over the network.

This exemplary embodiment may also be configured to transmit a compressed/encoded stream, not as an RTP packet, but as a file in which the stream is stored in a predetermined file format for transmission.

As the file format, the 3GP file format standardized by 3GPP may be used. For the detail of the 3GP file format, see the 3GPP TS26.244 standard.

The following describes the effect of the first exemplary embodiment of the present invention.

The resolution and image quality of a compressed bit stream of moving image content, which has been created for distribution to mobile terminals or over the Internet but is relatively low both in a bit rate and a screen resolution, are converted in this exemplary embodiment. The converted stream may be distributed via an NGN or via a mobile network, whose bandwidth will become wider in future. This means that this exemplary embodiment provides sufficient resolution and image quality.

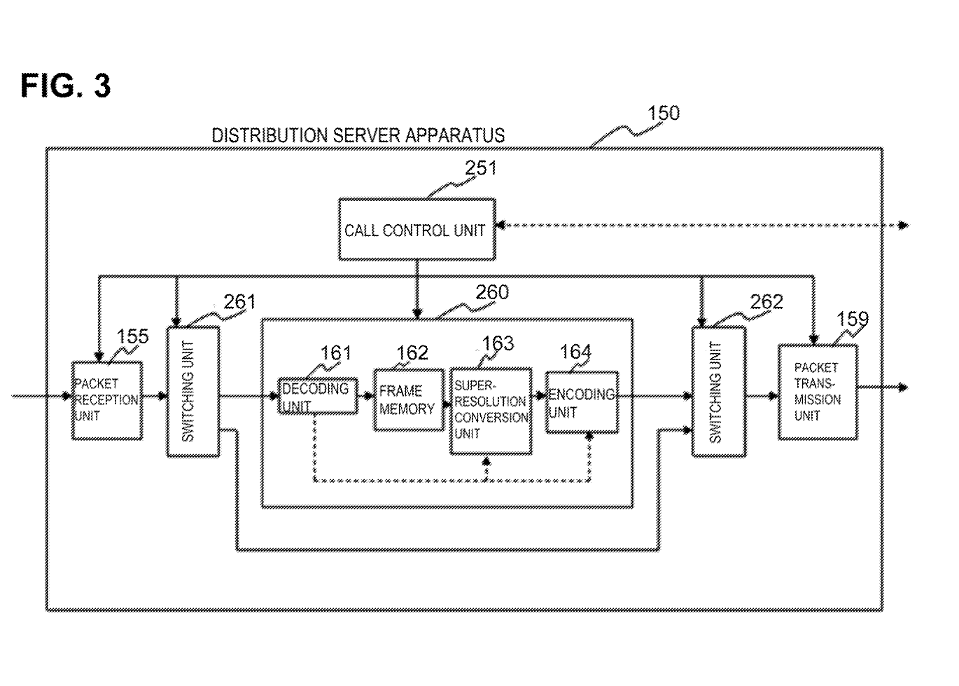

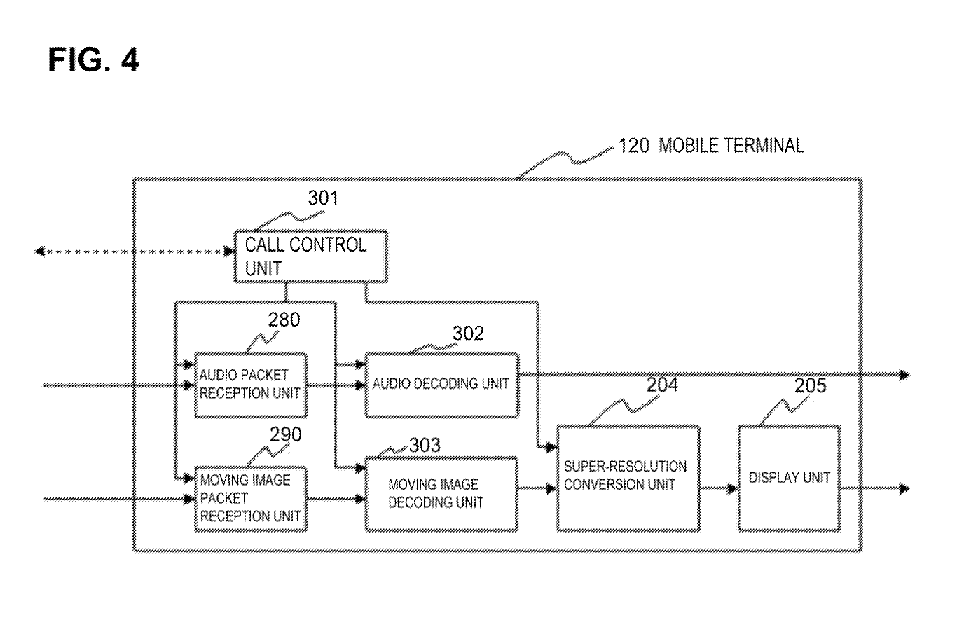

Next, a second exemplary embodiment of the present invention will be described. FIG. 3 is a diagram showing an example of the main part configuration of a distribution server apparatus in the second exemplary embodiment of the present invention. FIG. 4 is a diagram showing the main part configuration of a mobile terminal in the second exemplary embodiment of the present invention. In FIG. 3, the same reference numerals are used for the corresponding elements of FIG. 2. Because an element in FIG. 3 corresponding to an element with the same element in FIG. 2 performs the same operation, the description of the same element will be omitted below.

Referring to FIG. 3, the configuration of this exemplary embodiment is similar to that shown in FIG. 2 except that switching units 261 and 262 are provided to decide whether to perform the conversion processing via a conversion unit 260 or to bypass the conversion processing.

In FIG. 3, a call control unit 251 of the distribution server apparatus receives from a mobile terminal 120 a session start instruction using RTSP as well as capability information, which includes information indicating whether or not the mobile terminal 120 has a super-resolution conversion function, and a network bandwidth information using SDP, and analyzes the received information.

The call control unit 251 instructs a packet reception unit 155 to read a compressed/encoded stream, corresponding to the content specified by the mobile terminal, from compressed/encoded stream data 140.

The call control unit 251 uses network bandwidth information or terminal capability information to determine whether or not the server side is to perform the super-resolution conversion and outputs the determination result to the switching unit 261, switching unit 262, and conversion unit 260. This determination is made as follows.

If the network bandwidth is wide enough, if the terminal does not have a super-resolution conversion processing function, or if the terminal has a capability much higher than a compression/encoding capability of the content, the call control unit 251 judges that the distribution server apparatus 150 will perform the super-resolution conversion and instructs the switching unit 261 and the switching unit 262 to output and input the signal to and from the conversion unit 260.

In addition, the call control unit 251 instructs the conversion unit 260 to perform (turn on) the super-resolution conversion.

On the other hand, if the network bandwidth is not wide enough and if the mobile terminal 120 has the super-resolution conversion processing function, the call control unit 251 instructs the switching unit 261 and the switching unit 262 to bypass the conversion unit 260. In addition, the call control unit 251 instructs the conversion unit 260 to turn off the super-resolution conversion.

The switching unit 261 and the switching unit 262 receive the instruction from the call control unit 251 and perform switching between outputting/inputting to and from the conversion unit 260 and bypassing the conversion unit 260.

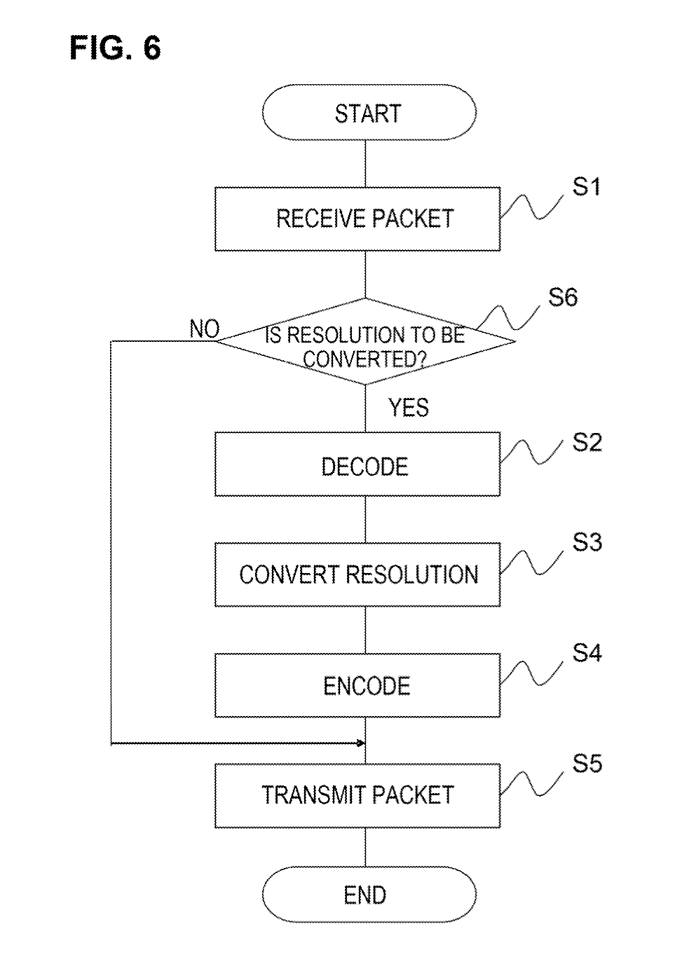

The following describes the processing procedure of the distribution server apparatus 150 in this exemplary embodiment with reference to FIG. 6.

Step S1: The packet reception unit 155 receives an RTP packet and reads a compressed/encoded stream.

Step S6: In case the super-resolution conversion processing is performed (YES in step S6), the switching unit 261 supplies the compressed/encoded stream to the decoding unit 161. In case the super-resolution conversion processing is not performed (NO in step S6), the switching units 261 and 262 supply the compressed/encoded stream to the packet transmission unit 159.

Because the operations of steps S2 to S5 are the same as those in FIG. 5, the description is omitted here.

The function and the processing of steps S1 to S6 of the distribution server apparatus described above may of course be implemented by one or more programs executed on the computer configuring the distribution server apparatus 150. As shown in FIG. 8A, the computer (CPU) that configures the distribution server apparatus implements the processing of the conversion unit, packet reception unit, packet transmission unit, call control unit, and switching units described above by loading the programs from the storage device into the memory for execution therein. The storage device, in which the programs are stored, may of course be connected to the distribution server apparatus over the network.

FIG. 4 is a diagram showing an example of the main part configuration of the mobile terminal 120 connected to the distribution server apparatus 150 shown in FIG. 3. Referring to FIG. 4, the mobile terminal 120 comprises a call control unit 301, a super-resolution conversion unit 204, a moving image decoding unit 303, an audio decoding unit 302, a moving image packet reception unit 290, and an audio packet reception unit 280.

The call control unit 301 transmits and receives session control signals to and from the distribution server using RTSP. In addition, the call control unit 301 transmits information, such as capability information on a mobile terminal, whether or not the mobile terminal has a super-resolution conversion function, and a network bandwidth, to the distribution server apparatus using SDP. The information received from the distribution server using SDP includes capability information on a video stream transmitted from the distribution server, whether or not the distribution server has a super-resolution conversion processing function, and capability information on an audio stream. The information is output from the call control unit 301 to the super-resolution conversion unit 204, moving image decoding unit 303, audio decoding unit 302, moving image packet reception unit 290, and audio packet reception unit 280.

In addition, the call control unit 301 instructs the super-resolution conversion unit 204 whether to turn on or off the super-resolution conversion processing. For example, in case capability information on a video stream received by the mobile terminal 120 indicates that a video codec is H.264 BP (Baseband Profile) Level 1.2, a bit rate is 384 kbps, a screen resolution is CIF, and a frame rate is 15 fps, and in case the super-resolution conversion processing is performed by the server side, the call control unit 301 instructs the super-resolution conversion unit 204 to turn off the conversion processing.

In case the super-resolution conversion processing on the distribution server side is off, the call control unit 301 outputs an instruction to the super-resolution conversion unit 204 to turn on the conversion processing.

On the other hand, the capability information on the audio codec is, assumed to include, for example, an AMR (Adaptive Multi-Rate) audio codec.

The moving image packet reception unit 290 receives the capability information on a video signal from the call control unit 301, receives a video RTP packet from the mobile network 130, reads the video stream stored in a payload of an RTP packet, and outputs the video stream to the moving image decoding unit 303.

The moving image decoding unit 303 receives the capability information on the video signal from the call control unit 301, reads the video stream from the moving image packet reception unit 290, decodes the video signal according to the capability information, and outputs the decoded video signal. For example, it is assumed in the description below that s compression/encoding scheme is H.264 BPP@L1.0, a screen resolution is QCIF, a bit rate is 64 kbps, and a frame rate is 15 fps.

The super-resolution conversion unit 204 receives from the call control unit 301 an instruction indicating whether the super-resolution conversion processing is to be turned on or off and receives the decoded video signal from the moving image decoding unit 303. In case the super-resolution conversion processing is on, the super-resolution conversion unit 204 improves the image quality by extending the screen resolution and outputs the converted video signal to a display unit 205.

The super-resolution conversion unit 204 extends, for example, the resolution corresponding to QCIF to the resolution corresponding to CIF in the same way as the super-resolution conversion unit 163 of the distribution server apparatus. To do so, there are the following two techniques: one is that the resolution is extended by increasing the number of pixels using a plurality of image frames as a reference image for an image frame to be converted and the other is that the number of pixels is increased using pixels in different positions in an image frame to be converted. The super-resolution conversion unit 204 may select an optimal technique from those techniques under the constraint of an operation amount and a memory amount that may be allotted to the processing. When a past reference frame is used, the super-resolution conversion unit 204 may be configured to receive a motion vector of each of the macro-blocks from the moving image decoding unit 303, to re-search pixels included in the macro-block for a detailed motion vector, based on the motion vector, and to increase the number of pixels of the frame to be converted by applying the detailed motion vector to pixels of a past reference image frame and by moving pixels in accordance with the motion vector. Of course, a configuration that does not use a motion vector is possible. In addition, when only the image frame whose resolution is to be increased is used, the image quality may be enhanced by performing the processing in which the resolution is enhanced by detecting an edge part and an increase in the number of pixels is applied to pixels near the edge, or in which pixels near the edge are corrected to make it feel as if the resolution was increased, or in which an edge is detected and emphasized. In addition, by estimating a motion direction, a frame image in a temporal direction may be interpolated to interpolate the frame rate. For example, the frame rate may be increased from 15 fps to 30 fps.

On the other hand, when the super-resolution conversion processing is off, the decoded video signal received from the moving image decoding unit 303 is output directly to the display unit 205.

The display unit 205 receives the converted moving image signal and displays it.

The audio packet reception unit 280 receives an audio RTP packet from the mobile network 130, reads an audio stream stored in the payload of the RTP packet, and outputs the audio stream.

The audio decoding unit 302 receives the audio codec information from the call control unit 301 as the capability information, receives the audio stream from the audio packet reception unit 280, decodes the audio, and outputs the decoded audio. The audio codec is, for example, the AMR audio codec.

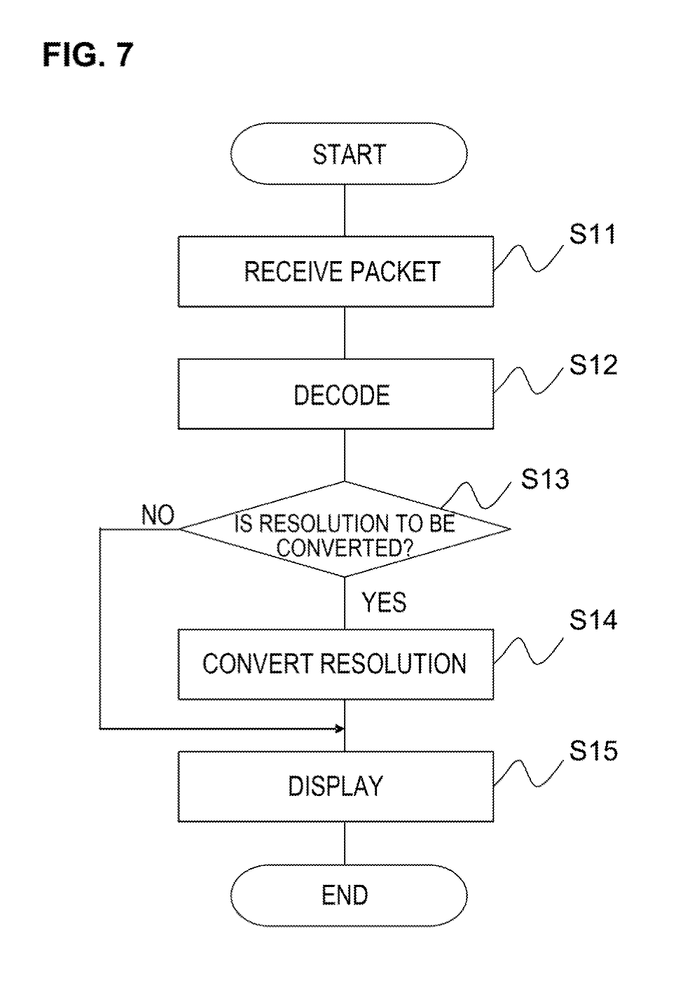

The following describes the processing procedure of the mobile terminal 120 with reference to FIG. 7.

Step S11: The moving image packet reception unit 290 receives an RTP packet and transmits a compressed/encoded stream to the moving image decoding unit 303.

Step S12: The moving image decoding unit 303 decodes the video signal.

Step S13: If the super-resolution conversion unit 204 performs the resolution conversion (YES in step S13) based on an instruction from the call control unit 301, the super-resolution conversion unit 204 improves the image quality by extending the resolution of the decoded image in step S14. If the super-resolution conversion unit 204 does not perform the resolution conversion (NO in step S13), the super-resolution conversion unit 204 transmits the video signal, received from the moving image decoding unit 303, directly to the display unit 205.

Step S15: The display unit 205 displays the signal received from the super-resolution conversion unit 204.

The function and the processing of steps S11 to S15 of the mobile terminal 120 described above may of course be implemented by a program executed on the computer configuring the mobile terminal. This is also true in the exemplary embodiment that will be described later. As shown in FIG. 8B, the computer (CPU) that configures the mobile terminal implements the processing of the conversion unit and other units, such as the moving image decoding unit described above, by executing one or more programs stored in a memory of the mobile terminal.

The following describes the effect of the second exemplary embodiment of the present invention.

In the second exemplary embodiment, the compressed bit stream of moving image content, which is low in a screen resolution, is utilized. In doing so, the distribution server may check a network bandwidth and a terminal capability to determine whether the bit stream will be converted on the distribution server before distribution or the bit stream will be directly distributed with no conversion on the distribution server but, instead, the resolution and the image quality will be enhanced on the terminal. This configuration provides sufficient resolution and image quality.

Although the call control unit that performs C-Plane (Control Plane) processing and the packet reception unit, conversion unit, packet copy unit, and packet transmission unit that performs U-Plane (User Plane) processing are all stored in the server apparatus in the exemplary embodiments described above, a configuration is also possible in which the C-Plane processing and the U-Plane processing are performed in separate apparatuses. Such a configuration ensures scalability independently for the C-Plane and the U-Plane.

Although stored in an RTP packet and distributed from the server apparatus a mobile terminal, a compressed/encoded stream may also be stored in a file format and transmitted to a mobile terminal via HTTP (HyperText Transport Protocol) or TCP (Transport Control Protocol). The 3GP file format is known as the file format. For the detail of the 3GP file format, see 3GPP TS26.244 standard.

Although the video (moving image) signal is processed in the exemplary embodiments described above, the same configuration is also possible for the still image signal.

Any video compression/encoding method may be used; for example, any of the compression/encoding scheme H.263, MPEG-4, and H.264 may be used. For example, for the detail of MPEG-4, see ISO/IEC 14496-2 Information Technology Coding of Audio Visual Object-Part 2: Visual standard.

As the method of distribution from the server to a mobile terminal, not only a unicast distribution described in the first exemplary embodiment but also a multicast distribution for distribution to a plurality of mobile terminals belonging to a multicast group and the broadcast distribution for distribution to an unspecified number of mobile terminals may also be used.

The whole or part of the exemplary embodiments disclosed above can be described as, but not limited to, the following supplementary notes.

(Supplementary note 1) A distribution server comprises:

a conversion unit that receives compressed/encoded signal of a moving image or a still image and performs conversion that enhances resolution and image quality of said received signal; and

a transmission unit that distributes said converted signal to a terminal via a network.

(Supplementary note 2) The distribution server according to supplementary note 1, further comprising

a control unit that determines, based on a network bandwidth or a terminal capability, whether

to perform the conversion that enhances resolution and image quality of the received signal with the conversion unit and to distribute the converted signal to the terminal over the network, or

to distribute the received signal to the terminal over the network without the conversion and to cause the terminal to perform conversion that enhances resolution and image quality of the received signal and to output the converted signal.

(Supplementary note 3) The distribution server according to supplementary note 1 or 2, wherein the conversion unit comprises:

a decoding unit that receives the compressed/encoded signal and decodes the received signal using a scheme corresponding to capability information on the terminal;

a resolution conversion unit that converts resolution of the decoded signal to improve image quality thereof; and

an encoding unit that receives a signal converted by the resolution conversion unit and encodes the received signal using the scheme corresponding to the capability information on the terminal.

(Supplementary note 4) The distribution server according to Supplementary note 3, wherein the resolution conversion unit re-searches a past reference image for a motion vector, based on a motion vector decoded by the decoding unit and converts resolution of the image signal using an image generated by applying the motion vector re-searched to the reference image.
(Supplementary note 5) A distribution system comprises:

a terminal; and

a distribution server that distributes a compressed/encoded signal of a moving image or a still image to the terminal over a network, wherein the distribution server comprises:

a conversion unit that receives a compressed/encoded signal of a moving image or a still image and performs conversion that enhances resolution and image quality of the received signal; and

a transmission unit that distributes the converted signal to the terminal via the network.

(Supplementary note 6) The distribution system according to supplementary note 5, wherein the distribution server further comprises:

a control unit that determines, based on a network bandwidth or a terminal capability, whether

to perform the conversion that enhances resolution and image quality of the received signal with the conversion unit and to distribute the converted signal to the terminal over the network, or

to distribute the received signal to the terminal over the network without the conversion and to cause the terminal to perform conversion that enhances resolution and image quality of the received signal and to output the converted signal.

(Supplementary note 7) A distribution system comprises:

a distribution server that receives a compressed/encoded signal of a moving image or a still image; and

a terminal that decodes the received signal; performs, if resolution or image quality of the received signal is insufficient, conversion that enhances resolution and image quality of the received signal, and displays the converted signal.

(Supplementary note 8) The distribution system according to supplementary note 7, wherein the terminal comprises:

a decoding unit that decodes the received signal;

a resolution conversion unit that converts resolution of the decoded signal to improve image quality thereof; and

a display unit that displays the converted image signal.

(Supplementary note 9) A terminal that receives an image signal including a moving image or a still image, from a distribution server via a network, the terminal comprising:

a reception unit that receives an image signal that includes the moving image or the still image;

a decoding unit that decodes the received image signal;

a conversion unit that performs conversion that converts resolution of the decoded image signal to improve image quality thereof;

a control unit that controls whether or not to cause the conversion unit to perform the conversion; and

a display unit that displays the converted signal if the conversion unit performs the conversion but displays a signal, received from the decoding unit, if the conversion unit does not perform the conversion.

(Supplementary note 10) A distribution method comprises
a distribution server receiving a compressed/encoded signal of a moving image or a still image;

the distribution server performing conversion that enhances resolution and image quality of the received signal; and
the distribution server distributing the converted signal to a terminal via a network.
   (Supplementary note 11) The distribution method according to Supplementary note 10, further comprising

the distribution server determining, based on a network bandwidth or a terminal capability, whether

to perform the conversion that enhances resolution and image quality of the received signal with the conversion unit and to distribute the converted signal to the terminal over the network, or

to distribute the received signal to the terminal over the network without the conversion and to cause the terminal to perform conversion that enhances resolution and image quality of the received signal and to output the converted signal.

(Supplementary note 12) The distribution method according to Supplementary note 10 or 11, wherein
the conversion performed by the distribution server comprises:

decoding the received signal using a scheme corresponding to capability information on the terminal;

converting resolution of the decoded signal to improve image quality thereof; and

receiving the converted signal and encoding the received signal using the scheme corresponding to capability information on the terminal.

(Supplementary note 13) A distribution method comprises

a distribution server receiving a compressed/encoded signal of a moving image or a still image and distributing the received signal to a terminal over a network; and

the terminal performing, if resolution or image quality of the received signal is insufficient, conversion that enhances resolution and image quality of the received signal and displaying the converted signal.

(Supplementary note 14) The distribution method according to Supplementary note 13, comprising:

the terminal decoding the received signal;

the terminal converting resolution of the decoded signal to improve image quality thereof; and

the terminal displaying the converted image signal.

(Supplementary note 15) A program, causing a computer which configures a distribution server, to execute:

processing that receives a compressed/encoded signal of a moving image or a still image and performs conversion that enhances resolution and image quality of the received signal; and

processing that distributes the converted signal to a terminal via a network.

(Supplementary note 16) The program according to Supplementary note 15, wherein the conversion processing comprises:

decoding processing that decodes the received signal using a scheme corresponding to capability information on the terminal;

resolution conversion processing that converts resolution of the decoded signal to improve image quality thereof; and

encoding processing that receives a signal converted by the resolution conversion unit, and encodes the received signal using the scheme corresponding to capability information on the terminal.

(Supplementary note 17) The program according to Supplementary note 15 or 16, further causing the computer to execute

processing that determines, based on a network bandwidth or a terminal capability, whether

to perform the conversion that enhances resolution and image quality of the received signal with the conversion unit and to distribute the converted signal to the terminal over the network, or

to distribute the received signal to the terminal over the network without the conversion and to cause the terminal to perform conversion that enhances resolution and image quality of the received signal and to output the converted signal.

(Supplementary note 18) A program, causing a computer which configures a terminal that receives an image signal including a moving image or a still image, from a distribution server via a network, to execute:

processing that receives an image signal that includes the moving image or the still image;

processing that decodes the received signal;

processing that determines whether or not a resolution of the decoded signal is to be converted;

conversion processing that performs resolution conversion which converts resolution of the decoded signal to improve image quality thereof, if the conversion is determined to be performed; and

processing that controls to display the converted signal, if the conversion is performed, and displaying the decoded signal, if the conversion is not performed.

The disclosure of Patent Documents given above is hereby incorporated by reference into this specification. The exemplary embodiments and the examples may be changed and adjusted in the scope of the entire disclosure (including claims) of the present invention and based on the basic technological concept. In the scope of the claims of the present invention, various disclosed elements may be combined and selected in a variety of ways. That is, it is apparent that the present invention includes various modifications and changes that may be made by those skilled in the art according to the entire disclosure, including claims, and technological concepts thereof.

What is claimed is:

1. A distribution server apparatus comprising:
a conversion unit that receives compressed/encoded signal of a moving image or a still image and performs conversion that enhances resolution and image quality of said received signal; and
a transmission unit that distributes said converted signal to a terminal via a network.

2. The distribution server apparatus according to claim 1, further comprising
a control unit that determines, based on a network bandwidth or a terminal capability, whether
to perform conversion that enhances resolution and image quality of said received signal with said conversion unit and to distribute said converted signal to said terminal over said network, or
to distribute said received signal to said terminal over said network without said conversion and to cause said terminal to perform conversion that enhances resolution and image quality of said received signal and to output said converted signal.

3. The distribution server apparatus according to claim 1, wherein said conversion unit comprises:
a decoding unit that receives said compressed/encoded signal and decodes said received signal using a scheme corresponding to capability information on said terminal;
a resolution conversion unit that converts resolution of said decoded signal to improve image quality thereof; and
an encoding unit that receives a signal converted by said resolution conversion unit and encodes said received signal using a scheme corresponding to said capability information on said terminal.

4. The distribution server apparatus according to claim 3, wherein said resolution conversion unit re-searches a past reference image for a motion vector, based on a motion vector decoded by said decoding unit and converts resolution of said image signal using an image generated by applying said motion vector re-searched to said reference image.

5. A distribution system comprising a distribution server apparatus according to claim 1, and
terminal
said distribution server apparatus that distributing a compressed/encoded signal of a moving image or a still image to said terminal over a network.

6. The distribution system according to claim 5, wherein said distribution server apparatus further comprises
a control unit that determines, based on a network bandwidth or a terminal capability, whether
to perform conversion that enhances resolution and image quality of said received signal with said conversion unit and to distribute said converted signal to said terminal over said network, or
to distribute said received signal to said terminal over said network without said conversion and to cause said terminal to perform conversion that enhances resolution and image quality of said received signal and to output said converted signal.

7. The distribution system according to 5, wherein
a said terminal decodes said signal received from said distribution server apparatus, performs, in case resolution or image quality of said received signal is insufficient, conversion that enhances resolution and image quality of said received signal, and displays said converted signal.

8. The distribution system according to claim 7, wherein said terminal comprises:
a decoding unit that decodes said signal received from said distribution server apparatus;
a resolution conversion unit that converts resolution of said decoded signal to improve image quality thereof; and
a display unit that displays said converted image signal.

9. A terminal that receives an image signal including a moving image or a still image, from a distribution server via a network, said terminal comprising:
a reception unit that receives an image signal that includes said moving image or still image;
a decoding unit that decodes said received image signal;
a conversion unit that performs conversion that converts resolution of said decoded image signal to improve image quality, thereof;
a control unit that controls whether or not to cause said conversion unit to perform said conversion; and
a display unit that displays said converted signal, in case said conversion unit performs said conversion, but displays a signal, received from said decoding unit, in case said conversion unit does not perform said conversion.

10. A distribution method comprising:
a distribution server receiving a compressed/encoded signal of a moving image or a still image;
said distribution server performing conversion that enhances resolution and image quality of said received signal; and
said distribution server distributing said converted signal to a terminal via a network.

11. The distribution method according to claim 10, further comprising:
said distribution server determining, based on a network bandwidth or a terminal capability, whether
to perform said conversion that enhances resolution and image quality of said received signal with said conversion unit and to distribute said converted signal to said terminal over said network, or
to distribute said received signal to said terminal over said network without said conversion and to cause said terminal to perform conversion that enhances resolution and image quality of said received signal and to output said converted signal.

12. The distribution method according to claim 10, wherein said conversion performed by said distribution server comprises:
decoding said received signal using a scheme corresponding to capability information on said terminal;
converting resolution of said decoded signal to improve image quality thereof; and
receiving said converted signal and encoding said received signal using said scheme corresponding to capability information on said terminal.

13. The distribution method according to claim 10, comprising:
said terminal performing, if resolution or image quality of said received signal is insufficient, conversion that enhances resolution and image quality of said received signal and displaying said converted signal.

14. The distribution method according to claim 13, comprising:
said terminal decoding said received signal;
said terminal converting resolution of said decoded signal to improve image quality thereof; and
said terminal displaying said converted image signal.

15-18. (canceled)
